(19) United States
(12) Patent Application Publication
(10) Pub. No.: US 2026/0287399 A1
(43) Pub. Date: Sep. 24, 2026

(54) THREE-PHASE CAPACITIVE POSITION SENSOR

(71) Applicant: Cypress Semiconductor Corporation, San Jose, CA (US)

(72) Inventors: Viktor Kremin, Lviv (UA); Igor Mrykhin, Lviv (UA); Vasyl Matichyn, Vynohradiv (UA)

(73) Assignee: Cypress Semiconductor Corporation, San Jose, CA (US)

(21) Appl. No.: 19/083,698

(22) Filed: Mar. 19, 2025

(51) Int. Cl. G01D 5/24; G01B 7/30

(52) U.S. Cl. CPC G01D 5/2403; G01B 7/30

(57) ABSTRACT

One or more computing devices, systems, and/or methods are provided. In an embodiment of the techniques presented herein, a position sensor comprises a position encoder configured to generate a three-phase signal indicative of a position of the position encoder in response to an excitation signal, and a control unit configured to perform a Clarke transform using the three-phase signal to generate an in-phase component and a quadrature component, and generate a position measurement based on the in-phase component and the quadrature component.

### BACKGROUND

Various sensing techniques may be used for sensing angular position or linear position to provide inputs for a user interface (e.g., knob, slider, etc.), to measure a position of industrial equipment (e.g., motor, mechanical assembly, position sensor. etc.). Some applications for position sensing include vehicle systems, industrial systems, or consumer products.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In an embodiment of the techniques presented, a position sensor comprises a stationary electrode plate comprising a first phase electrode, a second phase electrode, and a third phase electrode, a movable electrode plate proximate the stationary electrode plate, comprising a first movable electrode, a second movable electrode, and a third movable electrode, and a control unit configured to apply a first excitation signal on the first phase electrode, apply a second excitation signal on the second phase electrode, apply a third excitation signal on the third phase electrode, measure a first response on the first phase electrode, measure a second response on the second phase electrode, measure a third response on the third phase electrode, wherein movement of at least one of the first movable electrode, the second movable electrode, or the third movable electrode is a function of at least one of the first excitation signal applied to the first phase electrode, the second excitation signal applied to the second phase electrode, or the third excitation signal applied to the third phase electrode, perform a Clarke transform using the first response, the second response, and the third response to generate an in-phase component and a quadrature component, and generate a position measurement based on the in-phase component and the quadrature component.

In an embodiment of the techniques presented, a position sensor comprises a position encoder configured to generate a three-phase signal indicative of a position of the position encoder in response to an excitation signal, and a control unit configured to perform a Clarke transform using the three-phase signal to generate an in-phase component and a quadrature component, and generate a position measurement based on the in-phase component and the quadrature component.

In an embodiment of the techniques presented, a method comprises generating a three-phase signal indicative of a position of a position encoder in response to an excitation signal, performing a Clarke transform using the three-phase signal to generate an in-phase component and a quadrature component, and generating a position measurement of the position encoder based on the in-phase component and the quadrature component.

In an embodiment of the techniques presented, a system comprises means for generating a three-phase signal indicative of a position of a position encoder in response to an excitation signal, means for performing a Clarke transform using the three-phase signal to generate an in-phase component and a quadrature component, and means for generating a position measurement of the position encoder based on the in-phase component and the quadrature component.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a diagram of a position sensor, in accordance with some embodiments.

FIG. 2 is a diagram illustrating a method for position detection, in accordance with some embodiments.

FIGS. 3-6 are diagrams of layouts for a three-phase position encoder, in accordance with some embodiments.

FIGS. 7-9 are diagrams of three-phase linear encoders in accordance with some embodiments.

FIG. 10 is a diagram of a device, such including or comprising a processing unit, in accordance with some embodiments.

FIG. 11 illustrates an embodiment of a computer-readable medium, in accordance with some embodiments.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

It is to be understood that the following description of embodiments is not to be taken in a limiting sense. The scope of the present disclosure is not intended to be limited by the embodiments described hereinafter or by the drawings, which are taken to be illustrative only. The drawings are to be regarded as being schematic representations and elements illustrated in the drawings are not necessarily shown to scale. Rather, the various elements are represented such that their function and general purpose become apparent to a person skilled in the art.

All numerical values within the detailed description and the claims herein are modified by “about” or “approximately” the indicated value, and take into account experimental error and variations that would be expected by a person having ordinary skill in the art.

Position sensing finds applications in vehicle, industrial, and consumer applications. Angular position measurement may be used for generating control signals for user interfaces, industrial machines, mechanical assemblies, or other applications. In general, capacitive sensing systems based on capacitive sensors detect the changes in electrode capacitance (self-capacitance sensing) or the changes in capacitance between electrodes (mutual capacitance sensing) caused by a conductive object to obtain position information (e.g., angular or linear coordinates). Capacitive sensing is useful for detecting rapid changes in capacitance corresponding to changes in position, but it is more difficult to conduct absolute measurements of position due to capacitance drift resulting from changes in environmental conditions, for example.

In some embodiments, a position sensor includes stationary electrodes and movable electrodes (e.g., rotating or linear). The electrodes are arranged to generate three-phase capacitance signals. The capacitance signals change based on position and can be processed to indicate changes in position. In some embodiments, the position sensor employs mutual capacitance sensing, which is a less sensitive to environmental factors. The shapes of the electrodes are selected such that capacitance responses are sinusoidal or very close thereto to reduce a number of tuning thresholds and simplify a rotation angle calculation. The sensor electrodes may be provided in one plane to achieve low cost manufacturing by allowing the use of single layer conductive materials.

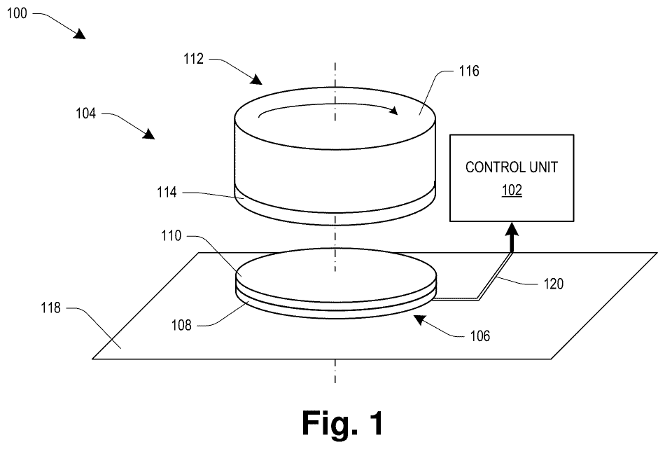

FIG. 1 is a diagram of position sensor 100, in accordance with some embodiments. In some embodiments, the position sensor 100 comprises a control unit 102 and a three-phase position encoder 104 comprising a stationary element 106 including an electrode plate 108 and a dielectric member 110 and a movable element 112 (e.g., rotating) comprising an electrode plate 114 and a dielectric member 116. In some embodiments, the dielectric member 116 is spaced from the electrode plate 114 to provide an intervening air gap. The stationary element 106 may be mounted on a circuit board 118 connected by traces or wires to the control unit 102. The control unit 102 may be mounted to the circuit board 118. The electrode plate 108 comprises a multiple of three electrodes and the electrode plate 114 also includes a multiple of three electrodes. In some embodiments, a dielectric liquid may separate the electrode plate 108 and the electrode plate 114, for example in a liquid cooled motor.

In some embodiments, the control unit 102 is implemented as hardware (e.g., a microprocessor, etc.) or a combination of hardware and software (e.g., a PSoC™, an ASIC, etc.). In some embodiments, the control unit 102 is a CapSense™ microcontroller. The position sensor 100 may be employed in a system that includes other types of sensors, such as capacitive buttons/sliders, a capacitive touch-screen, capacitive proximity sensors, capacitive force sensors, non-capacitive sensors (e.g., light, voltage, current) managed by the control unit 102.

In some embodiments, the control unit 102 applies an excitation signal on the three-phase electrodes of the electrode plate 108. In an embodiment where the control unit 102 comprises at least three sensing channels, the excitation signal may be applied to the three-phase electrodes of the electrode plate 108 in parallel and the responses may be measured concurrently. In an embodiment where the control unit 102 comprises a single sensing channel, time interleaving may be used to apply the excitation signal sequentially to one of the three-phase electrodes of the electrode plate 108 and the responses for each phase may be measured sequentially. Alternatively, with a single sensing channel, multiphase sensing may be used where the excitation signal is applied to the three-phase electrodes of the electrode plate 108 concurrently, however, different phases of the TX signal may be used to shift the phase sequence and the response may be read using the single channel. Sequence deconvolution may be used to generate individual sensor readings. A capacitance response to the excitation signal depends on the degree of overlap between the three-phase electrodes of the electrode plate 108, and the movable electrodes of the electrode plate 114. In some embodiments, the control unit 102 measures mutual capacitance.

The capacitance response of the three-phase position encoder 104 is represented by:

$${C}_{phaseA} = {C}_{base} + {C}_{0} \cdot ( 1 + cos ( φ ) ) , \qquad ( 1 )$$

$${C}_{phaseB} = {C}_{base} + {C}_{0} \cdot ( 1 + cos ( φ + \frac{2 π}{3} ) ) , and \qquad ( 2 )$$

$${C}_{phaseC} = {C}_{base} + {C}_{0} \cdot ( 1 + cos ( φ - \frac{2 π}{3} ) ) . \qquad ( 3 )$$

where C_{phaseA}, C_{phaseB}, C_{phaseC} are the capacitance responses of the three-phase electrodes for phases A, B, and C, respectively, C_{base} is a baseline parasitic capacitance component of the three-phase position encoder 104, C₀ is half of the maximum capacitance response of the three-phase position encoder 104, and φ is the angle in electrical degree (i.e., rotation angle times number of movable electrodes).

The control unit 102 employs a Clarke transform to convert the responses from the three-phase position encoder 104 to in-phase and quadrature components according to:

$$\vert \begin{matrix}{c}_{i} \\ {c}_{q} \\ {c}_{base}\end{matrix} \vert = {K}_{c} \vert \begin{matrix}{C}_{phaseA} \\ {C}_{phaseB} \\ {C}_{phaseC}\end{matrix} \vert . \qquad ( 4 )$$

$${K}_{c} = \frac{2}{3} \vert \begin{matrix}1 & - \frac{1}{2} & - \frac{1}{2} \\ 0 & \frac{\sqrt{3}}{2} & - \frac{\sqrt{3}}{2} \\ \frac{1}{2} & \frac{1}{2} & \frac{1}{2}\end{matrix} \vert . \qquad ( 5 )$$

where K_{C} is the direct Clarke transform matrix.

After the Clarke transform, the encoder response is:

$$\vert \begin{matrix}{c}_{i} \\ {c}_{q} \\ {c}_{base}\end{matrix} \vert = \vert \begin{matrix}{C}_{0} cos ( φ ) \\ {C}_{0} sin ( φ ) \\ {C}_{base} + {C}_{0}\end{matrix} \vert . \qquad ( 6 )$$

Equation 6 is solved to generate the measured angle based on the in-phase and quadrature components:

$$φ = ARCTAN ( {c}_{i} , {c}_{q} ) . \qquad ( 7 )$$

The electrical angle corresponds to the physical (mechanical) angle based on the number (N) of movable electrodes:

$$MechAngle = \frac{φ}{N} . \qquad ( 8 )$$

In addition to the in-phase (cᵢ) and (c_{q}) quadrature capacitance components, the control unit 102 also obtains the baseline capacitance component, C_{base}+C₀. The C_{base}+C₀ capacitance component is expected to be substantially constant during operation and can be used as safety/self-diagnostic feature, as derivation from the constant value may indicate a system malfunction.

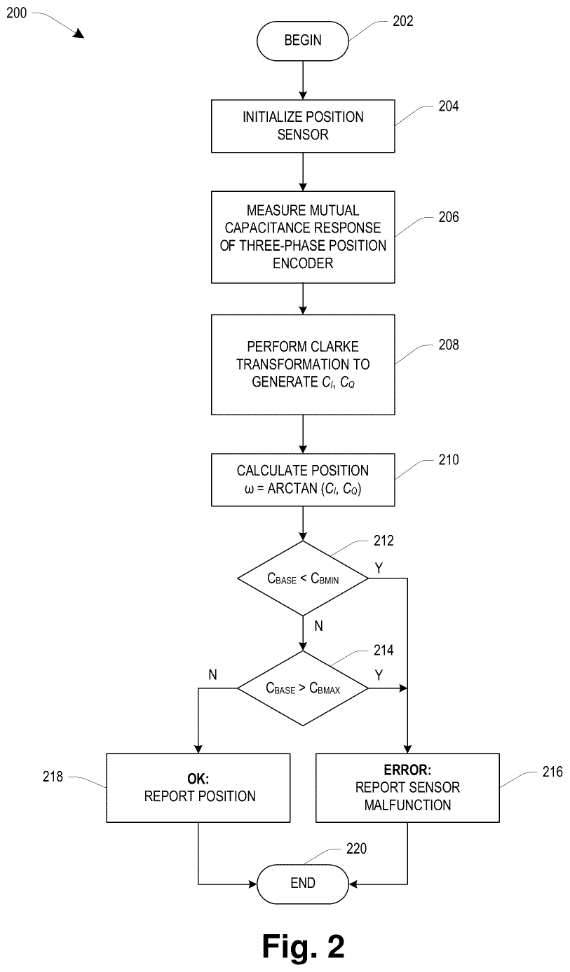

FIG. 2 is a diagram illustrating a method 200 for position detection, in accordance with some embodiments. The method begins at 202. At 204, the position sensor 100 is initialized. At 206, the control unit 102 measures the mutual capacitance of the three-phase position encoder 104. The mutual capacitance measurements may be generated in parallel if the control unit 102 has three channels or sequentially if the control unit 102 has a single channel. At 208, the control unit 102 performs a Clarke transform to generate in-phase (cᵢ) and (c_{q}) quadrature capacitance components. At 210, the control unit 102 generates a position measurement (e.g., angular position) based on the arctangent of the in-phase (cᵢ) and (c_{q}) quadrature capacitance components. The calculation covers the full range of the electrical angle (0-360°) by considering the values and signs of the both cᵢ and c_{q} values (Note: cᵢ and c_{q} can be negative after the Clarke transform). At 212 and 214, the control unit compares the base capacitance component to a minimum threshold (C_{bmin}) and a maximum threshold (C_{bmax}), respectively. If either threshold check fails at 212 or 214, the control unit 102 reports an error malfunction at 216. Otherwise, if both threshold checks pass at 212 and 214, the control unit 102 reports the position at 218. The control unit 102 may convert the electrical angle position to a mechanical angle position. The method 200 ends at 220.

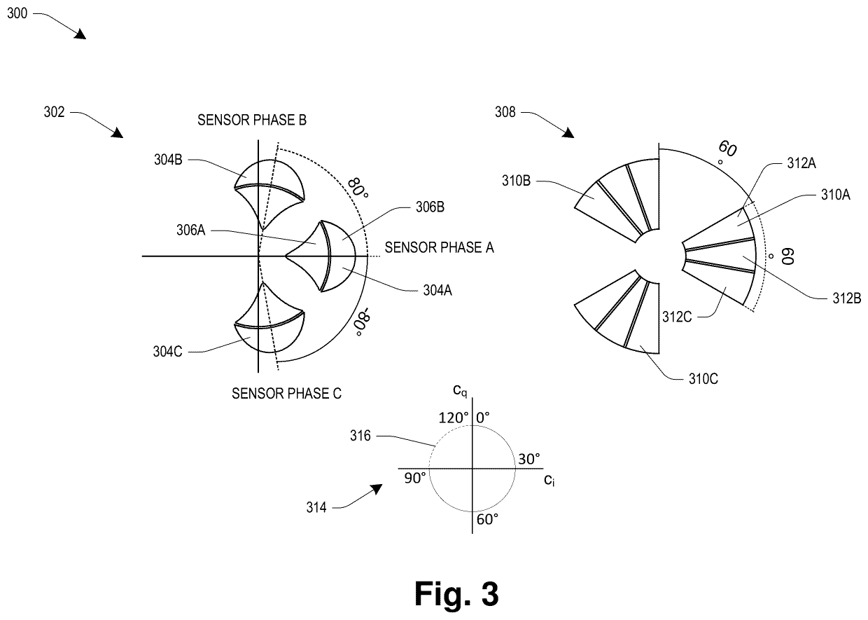

Examples of electrode layouts for the three-phase position encoder 104 are illustrated in FIGS. 3-6, in accordance with some embodiments. FIG. 3 illustrates a three-phase absolute position encoder 300 with a mechanical angle range of 0-90°, in accordance with some embodiments. The three-phase absolute position encoder 300 comprises a stationary electrode plate 302 with three-phase electrodes 304A, 304B, 304C. In some embodiments, the three-phase electrodes 304A, 304B, 304C have petal shapes to facilitate a sinusoidal capacitance response. The three-phase electrodes 304A, 304B, 304C are spaced by about 80° on center. As illustrated for the three-phase electrode 304A, each three-phase electrode 304A, 304B, 304C comprises segments 306A, 306B separated by dielectric material.

In some embodiments, three-phase absolute position encoder 300 comprises a rotating electrode plate 308 with three rotating electrodes 310A, 310B, 310C. Each rotating electrode 310A, 310B, 310C may span about 60°, and the rotating electrodes 310A, 310B, 310C are spaced by about 60° on center. The rotating electrodes 310A, 310B, 310C may have an arc trapezoidal shape. As illustrated for the rotating electrode 310A, each rotating electrode 310A, 310B, 310C comprises segments 312A, 312B, 312C separated by dielectric material so that a given segment 312A, 312B, 312C does not concurrently overlap more than one of the three-phase electrodes 304A, 304B, 304C. The relationship between mechanical angle and the measured in-phase (c_{q}) and (c_{q}) quadrature capacitance components is illustrated in a diagram 314 showing the mechanical angle range of 0-90°. Baseline tracking is not needed for the three-phase absolute position encoder 300. In the dashed region 316, the sensor response is valid but is ambiguous near the 120°/0° point so the working range of the three-phase absolute position encoder 300 is set from 0°-90°.

In the three-phase absolute position encoder 300 the three rotating electrodes 310A, 310B, 310C provide a 360° electrical signal corresponding to 120° physical/mechanical position (i.e., 360°/3=120°). To provide a phase shift of ±120° between adjacent stationary three-phase electrodes 304A, 304B, 304C the last three-phase electrode 304A, 304B, 304C is shifted by ±120°/3=±40° in physical/mechanical position. To avoid electrode overlapping with the three-phase electrodes 304A, 304B, 304C of the stationary electrode plate 302, a ±120° physical position shift that corresponds to ±360° electrical degree is provided resulting in the spacing of the three-phase electrodes 304A, 304B, 304C being 80° (i.e., ±120°−±40°=±80°).

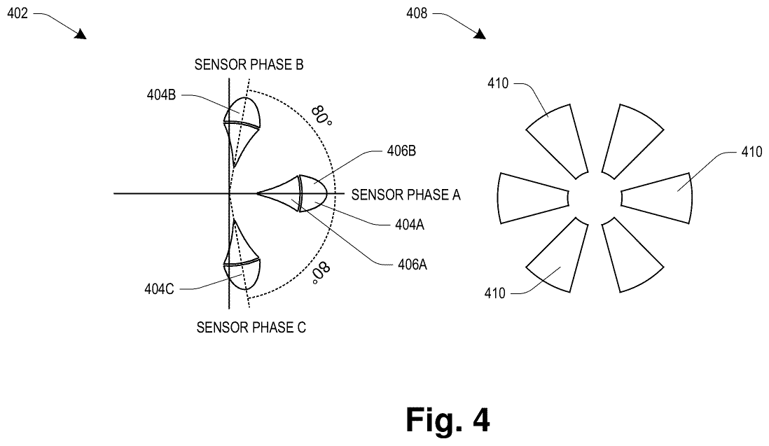

FIG. 4 illustrates a three-phase incremental position encoder 400, in accordance with some embodiments. The three-phase incremental position encoder 400 comprises a stationary electrode plate 402 with three-phase electrodes 404A, 404B, 404C. In some embodiments, the three-phase electrodes 404A, 404B, 404C have petal shapes to facilitate a sinusoidal capacitance response. The three-phase electrodes 404A, 404B, 404C are spaced by about 80° on center. As illustrated for the three-phase electrode 404A, each three-phase electrode 404A, 404B, 404C comprises segments 406A, 406B separated by dielectric material.

In some embodiments, the three-phase incremental position encoder 400 comprises a rotating electrode plate 408 with six evenly spaced rotating electrodes 410, providing a mechanical rotation angle of 60° corresponding to a 360° electrical angle. The rotating electrodes 410 may have arc trapezoidal shapes spanning and angle of about 30° and spaced by about 300.

In the three-phase incremental encoder 400 the three rotating electrodes 410 provide a 360° electrical signal corresponding to 120° physical/mechanical position (i.e., 360°/3=120°). A ±360° electrical position corresponds to ±20° physical position resulting in the spacing of the three-phase electrodes 404A, 404B, 404C being 80° (i.e., ±60°+±20°=+80°).

In the case of the three-phase incremental position encoder 400, a threshold may be used to identify movement between two measurements, C1, C2. The Euclidean distance is determined between the coordinates (cᵢ, c_{q}) of the sequential measurements and compared to a threshold. A position change is only reported if the Euclidean distance is greater than the threshold. The angle change is based on the angles for the measurements, C1, C2

The control unit 102 reports angle incremental changes based on consecutive angle measurements. In some applications, absolute angle measurements are not required, but rather only incremental measurements are employed. For example, certain control knobs, such as a volume control, do not have designated start and stop positions, but rather only operate based on relative position changes. Other applications, such as motor control, may combine an incremental position measurement generated by the three-phase incremental position encoder 400 with an absolute position measurement from a different sensor, such as a magnet sensor, to calculate angular position and angular velocity. The control unit 102 or an external controller may use incremental position measure absolute position over time.

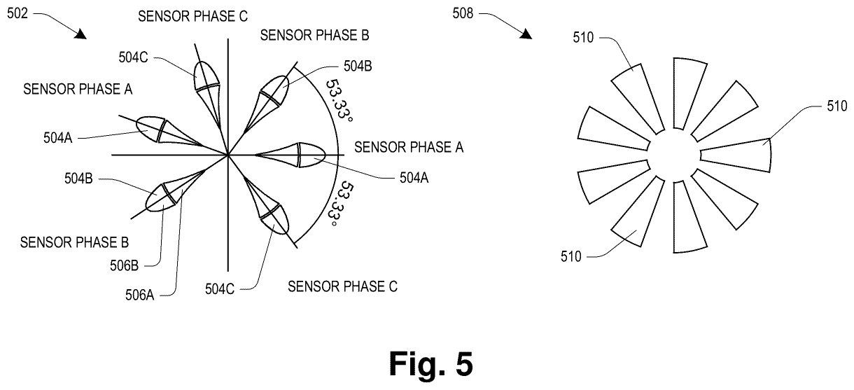

FIG. 5 illustrates a three-phase incremental position encoder 500, in accordance with some embodiments. The three-phase incremental position encoder 500 comprises a stationary electrode plate 502 with three-phase electrodes 504A, 504B, 504C grouped in pairs. In some embodiments, the three-phase electrodes 504A, 504B, 504C each have petal shapes to facilitate a sinusoidal capacitance response. The three-phase electrodes 504A, 504B, 504C are spaced by about 53.33° on center. As illustrated for one of the three-phase electrodes 504A, each three-phase electrode 504A, 504B, 504C comprises segments 506A, 506B separated by dielectric material. The control unit 102 excites each pair of three-phase electrodes 504A, 504B, 504C in parallel with the same excitation signal and measures the response of each pair of three-phase electrodes 504A, 504B, 504C in parallel.

In some embodiments, the three-phase incremental position encoder 500 comprises a rotating electrode plate 508 with nine evenly spaced rotating electrodes 510, providing a mechanical rotation angle of 40° corresponding to a 360° electrical angle. The rotating electrodes 510 may have arc trapezoidal shapes spanning and angle of about 20+θ and spaced by about 20°. With nine rotating electrodes 510 the spacing between the three-phase electrodes 504A, 504B, 504C is 360°/9+360°/9/3=40°+40°/3=160°/3=53.33°. Increasing the number of three-phase electrodes 504A, 504B, 504C and rotating electrodes 510 increases the resolution of the three-phase incremental position encoder compared to the embodiment of FIG. 4.

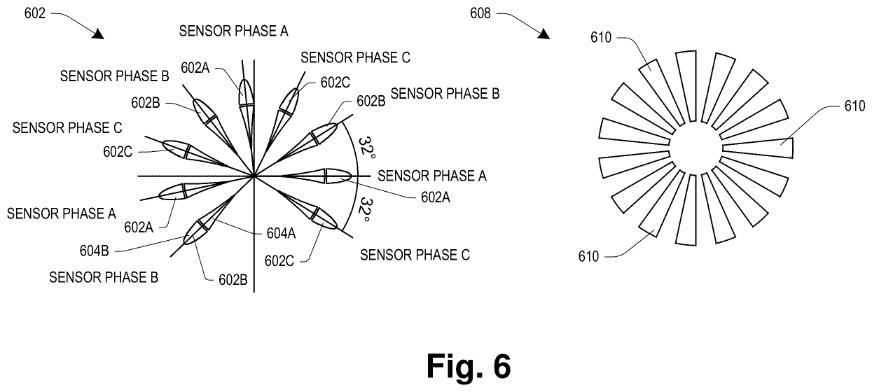

FIG. 6 illustrates a three-phase incremental position encoder 600, in accordance with some embodiments. The three-phase incremental position encoder 600 comprises a stationary electrode plate 602 with three-phase electrodes 604A, 604B, 604C arranged in triplets (i.e. three for each phase). In some embodiments, the three-phase electrodes 604A, 604B, 604C each have petal shapes to facilitate a sinusoidal capacitance response. The three-phase electrodes 604A, 604B, 604C are spaced by about 32° on center. As illustrated for one of the three-phase electrodes 604A, each three-phase electrode 604A, 604B, 604C comprises segments 606A, 606B separated by dielectric material. The control unit 102 excites each triplet of three-phase electrodes 504A, 504B, 504C in parallel with the same excitation signal and measures the response of each triplet of three-phase electrodes 504A, 504B, 504C in parallel.

In some embodiments, the three-phase incremental position encoder 600 comprises a rotating electrode plate 608 with 15 evenly spaced rotating electrodes 610, providing a mechanical rotation angle of 24° corresponding to a 360° electrical angle. The rotating electrodes 610 may have arc trapezoidal shapes spanning and angle of about 12° and spaced by about 12°. Increasing the number of three-phase electrodes 604A, 604B, 604C and rotating electrodes 610 increases the resolution of the three-phase incremental position encoder compared to the embodiments of FIG. 4 or 5.

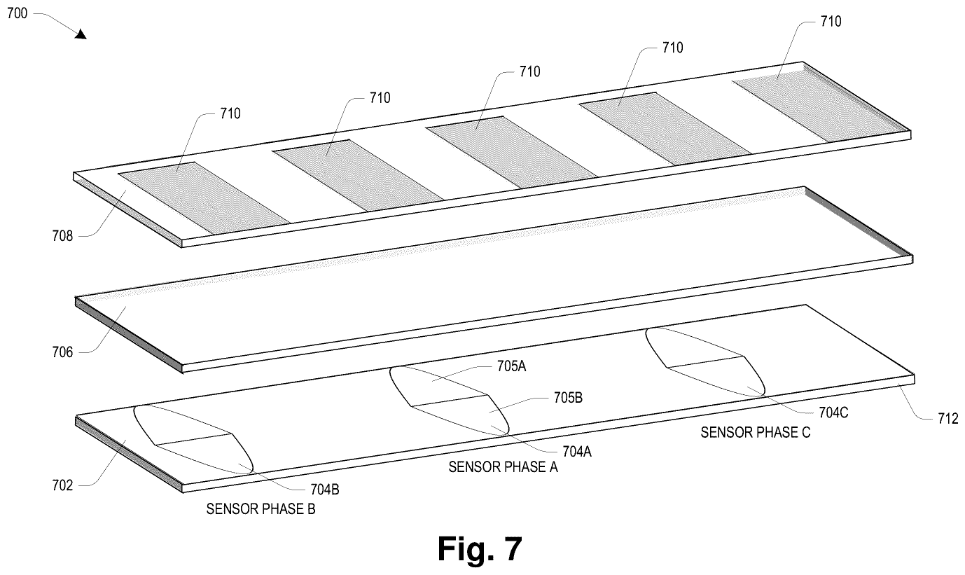

FIGS. 7-9 illustrate embodiments of three-phase linear encoders 700, 800 in accordance with some embodiments. The linear encoders 700, 800 use the same principle as the rotational position encoders, but place the sensor electrodes in a line sequentially instead of in a circular arrangement. The linear encoder can be provided with an arbitrary number of movable electrodes on the movable electrode plate. The movable electrodes are spaced with the same period (or pitch) L. At least 3 stationary electrodes are placed to provide three 120° phase shifted signals during movement of the movable electrode plate.

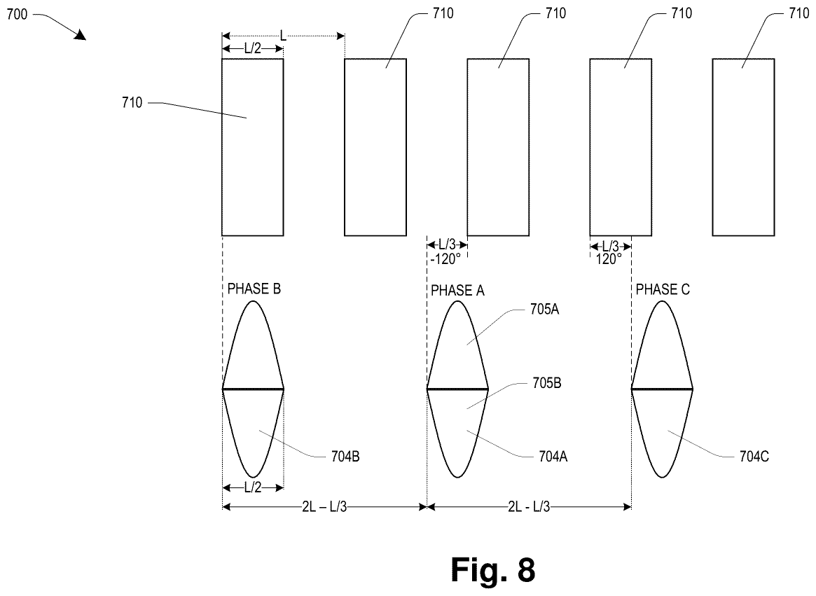

Referring to FIGS. 7 and 8, the three-phase linear encoder 700 comprises a stationary electrode plate 702 comprising three-phase electrodes 704A, 704B, 704C, a dielectric member 706, and a movable electrode plate 708 comprising movable electrodes 710. In some embodiments, the dielectric member 706 is spaced from the movable electrode plate 708 to provide an intervening air gap. The stationary electrode plate 702 may be mounted on a circuit board 712 connected by traces or wires to the control unit 102 (not illustrated in FIG. 7). As illustrated for the three-phase electrode 704A, each three-phase electrode 704A, 704B, 704C comprises segments 705A, 705B separated by dielectric material.

FIG. 8 illustrates the relative spacing of the three-phase electrodes 704A, 704B, 704C and the movable electrode 710. The positions of the pairs of stationary electrodes for phases A, B and C are defined by:

$${X}_{pos A} = ( 5 \cdot k + 1 \frac{2}{3} ) \cdot L , \qquad ( 9 )$$

$${X}_{pos B} = 5 \cdot k \cdot L \qquad ( 10 )$$

$${X}_{pos C} = ( 5 \cdot k + 3 \frac{1}{3} ) \cdot L , k = 0 , 1 , 2 , \qquad ( 11 )$$

where k is the index of the pair of electrodes and L is the period (pitch) of the movable electrodes 710, which are situated uniformly. The three-phase electrodes 704A, 704B, 704C and the movable electrode 710 are matched at a 0° offset for phase B, a −120° offset for phase A, and a 120° offset for phase C. The position is calculated using the Clarke transform and the arctangent function described in Equations 4-7 above. The angle coordinates are converted to linear coordinates by:

$$X = L \frac{{φ}_{pos}}{360 °} . \qquad ( 12 )$$

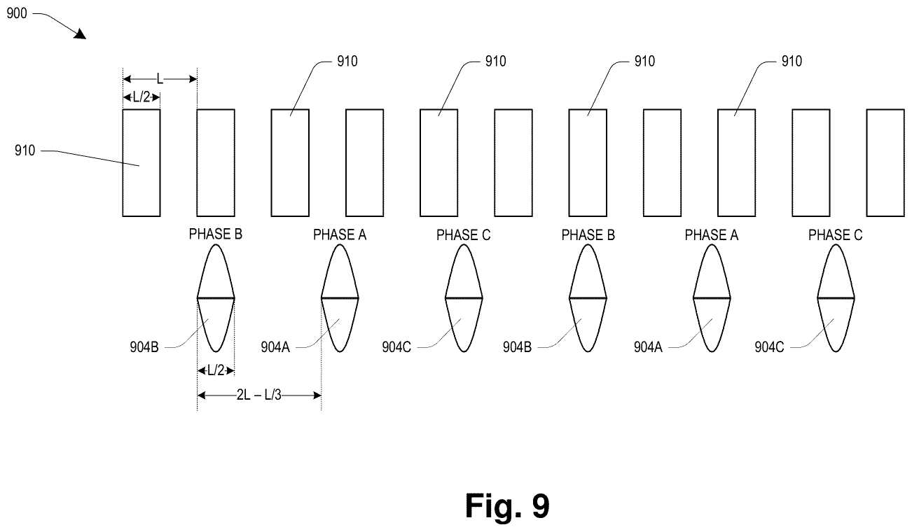

FIG. 9 illustrates a three-phase linear encoder 900 comprising a stationary electrode plate 902 comprising three-phase electrodes 904A, 904B, 904C grouped (repeated) in pairs and a movable electrode plate 908 comprising movable electrodes 910. As illustrated for the three-phase electrode 904A, each three-phase electrode 904A, 904B, 904C comprises segments 905A, 905B separated by dielectric material. The use of additional three-phase electrodes 904A, 904B, 904C and movable electrodes 910 increases the linear travel of the three-phase linear encoder 900. Additional sets of three-phase electrodes 904A, 904B, 904C and movable electrodes 910 may be provided to further increase the linear travel.

It should be noted that for correct encoder operation, the control unit 102 (see FIG. 1) senses the phase sensor capacitances and calculates the linear displacement periodically and updates the total moving plate travel distance X to ensure the moving electrode plate 708, 908 does not travel more than L/2 between sequential readings for the correct total displacement X calculation. The same principle is also valid for the angular position encoder operation, where the sampling rate should be fast enough to move the electrodes between next adjacent stationary electrodes. In general, a higher sample rate might provide better reading accuracy during movements as capacitance measuring also takes some time, so for the typical measurement circuits the readings are proportional to the average capacitance value during measurement window.

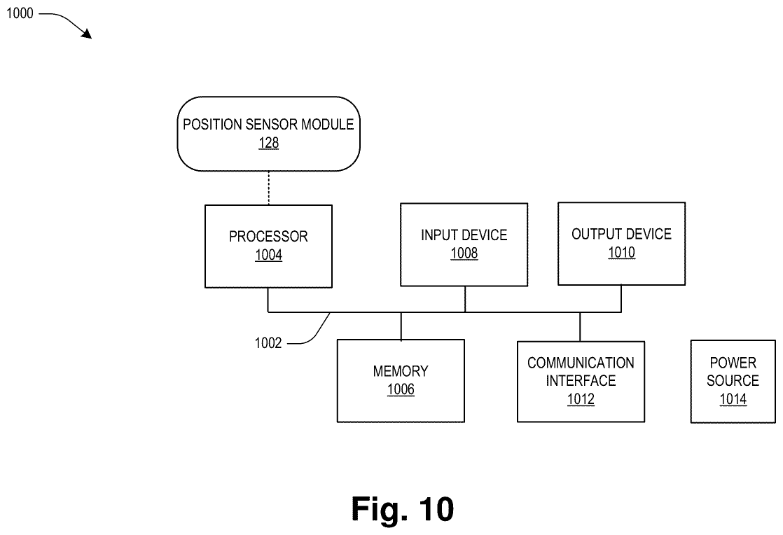

FIG. 10 is a diagram of a device 1000 for implementing the control unit 102, in accordance with some embodiments. In some embodiments, the device 1000 comprises a bus 1002, a processor 1004 (e.g., the processor 126), a memory 1006 that stores software instructions or operations, an input device 1008, an output device 1010, a communication interface 1012, and a power source 1014, such as a battery. The processor 1004 that implements a position sensing module 1016. The device 1000 may include fewer components, additional components, different components, and/or a different arrangement of components than those illustrated in FIG. 10.

According to some embodiments, the bus 1002 includes a path that permits communication among the components of the device 1000. For example, the bus 1002 may include a system bus, an address bus, a data bus, and/or a control bus. The bus 1002 may also include bus drivers, bus arbiters, bus interfaces, clocks, and so forth. The processor 1004 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. The processor 1004 may be implemented as hardware (e.g., a microprocessor, etc.), a combination of hardware and software (e.g., a SoC, an ASIC, etc.), may include one or multiple memories (e.g., cache, etc.), etc.

In some embodiments, the processor 1004 controls the overall operation or a portion of the operation(s) performed by the control unit 102. The processor 1004 performs one or multiple operations based on an operating system and/or various applications or computer programs (e.g., software). The processor 1004 accesses instructions from the memory 1006, from other components of the device 1000, and/or from a source external to the device 1000 (e.g., a network, another device, etc.). The processor 1004 may perform an operation and/or a process based on various techniques including, for example, multithreading, parallel processing, pipelining, interleaving, etc.

In some embodiments, the memory 1006 includes one or multiple memories and/or one or multiple other types of storage mediums. For example, the memory 1006 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory, and/or some other suitable type of memory. The memory 1006 may include a hard disk, a magnetic disk, an optical disk, a magneto-optic disk, a solid state disk, a Micro-Electromechanical System (MEMS)-based storage medium, a nanotechnology-based storage medium, and/or some other suitable disk. The memory 1006 may include drives for reading from and writing to the storage medium. The memory 1006 may be external to and/or removable from the device 1000, such as, for example, a Universal Serial Bus (USB) memory stick, a dongle, a hard disk, mass storage, off-line storage, or some other type of storing medium (e.g., a compact disk (CD), a digital versatile disk (DVD), a Blu-Ray disk (BD), etc.). The memory 1006 may store data, software, and/or instructions related to the operation of the position sensor 100.

The communication interface 1012 permits the device 1000 to communicate with other devices, networks, systems, sensors, and/or the like on a network. The communication interface 1012 may include one or multiple wireless interfaces and/or wired interfaces. For example, the communication interface 1012 may include one or multiple transmitters and receivers, or transceivers. The communication interface 1012 may operate according to a protocol stack and a communication standard. In some embodiments, the communication interface 1012 includes an antenna. The communication interface 1012 may include various processing logic or circuitry (e.g., multiplexing/de-multiplexing, filtering, amplifying, converting, error correction, etc.). In some embodiments, the communication interface 1012 operates using a long range wireless protocol, such as a cellular protocol or a WiFi protocol, a short range protocol, such as BLUETOOTH™, or a wired protocol, such as Ethernet.

In some embodiments, the input device 1008 permits an input into the device 1000. For example, the input device 1008 may comprise a keyboard, a mouse, a display, a touchscreen, a touchless screen, a button, a switch, an input port, speech recognition logic, and/or some other type of suitable visual, auditory, or tactile input component. The output device 1010 permits an output from the device 1000. For example, the output device 1010 may include a speaker, a display, a touchscreen, a touchless screen, a projected display, a light, an output port, and/or some other type of suitable visual, auditory, or tactile output component. In some embodiments, the output device 1010 may be remote and may communicate with the processor 1004 using the communication interface 1012.

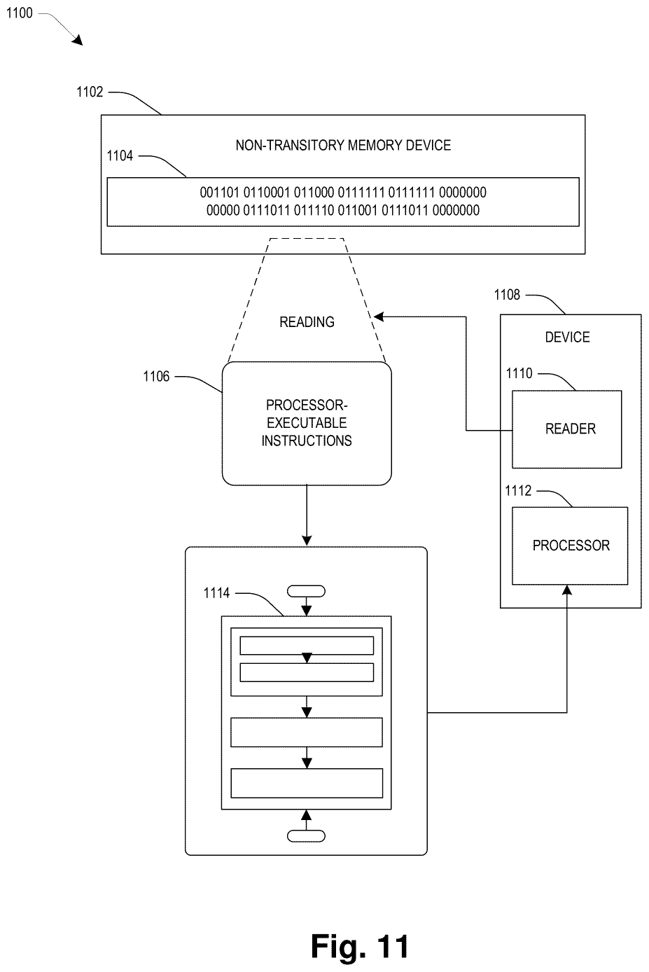

FIG. 11 illustrates an exemplary embodiment 1100 of a computer-readable medium 1102, in accordance with some embodiments. One or more embodiments involve a computer-readable medium comprising processor-executable instructions configured to implement one or more of the techniques presented herein. The embodiment 1100 comprises a non-transitory computer-readable medium 1102 (e.g., a CD-R, DVD-R, flash drive, a platter of a hard disk drive, etc.), on which is encoded computer-readable data 1104. This computer-readable data 1104 in turn comprises a set of processor-executable computer instructions 1106 that, when executed by a computing device 1108 including a reader 1110 for reading the processor-executable computer instructions 1106 and a processor 1112 for executing the processor-executable computer instructions 1106, are configured to facilitate operations according to one or more of the principles set forth herein. In some embodiments, the processor-executable computer instructions 1106, when executed, are configured to facilitate performance of a method 1114, such as at least some of the aforementioned method(s). In some embodiments, the processor-executable computer instructions 1106, when executed, are configured to facilitate implementation of a system, such as at least some of the one or more aforementioned system(s). Many such computer-readable media may be devised by those of ordinary skill in the art that are configured to operate in accordance with the techniques presented herein.

In an embodiment of the techniques presented, a position sensor comprises a stationary electrode plate comprising a first phase electrode, a second phase electrode, and a third phase electrode, a movable electrode plate proximate the stationary electrode plate, comprising a first movable electrode, a second movable electrode, and a third movable electrode, and a control unit configured to apply a first excitation signal on the first phase electrode, apply a second excitation signal on the second phase electrode, apply a third excitation signal on the third phase electrode, measure a first response on the first phase electrode, measure a second response on the second phase electrode, measure a third response on the third phase electrode, wherein movement of at least one of the first movable electrode, the second movable electrode, or the third movable electrode is a function of at least one of the first excitation signal applied to the first phase electrode, the second excitation signal applied to the second phase electrode, or the third excitation signal applied to the third phase electrode, perform a Clarke transform using the first response, the second response, and the third response to generate an in-phase component and a quadrature component, and generate a position measurement based on the in-phase component and the quadrature component.

In an embodiment of the techniques presented, the first phase electrode, the second phase electrode, and the third phase electrode are spaced relative to the first movable electrode, the second movable electrode, and the third movable electrode such that one of the first phase electrode, the second phase electrode, or the third phase electrode overlaps one of the first movable electrode, the second movable electrode, or the third movable electrode.

In an embodiment of the techniques presented, the first movable electrode comprises three segments.

In an embodiment of the techniques presented, the position measurement comprises an angle measurement, and the control unit is configured to compare a first ordered pair comprising the in-phase component and the quadrature component to a second ordered pair comprising a previous value of the in-phase component and a previous value of the quadrature component to identify an angle change and generate the angle measurement responsive to identifying the angle change.

In an embodiment of the techniques presented, the control unit is configured to identify the angle change responsive to a distance between the first ordered pair and the second ordered pair exceeding a threshold.

In an embodiment of the techniques presented, the movable electrode plate comprises a set of movable electrodes including the first movable electrode, the second movable electrode, and the third movable electrode, a number of movable electrodes in the set of movable electrodes is a multiple of three, and the movable electrodes in the set are spaced by 360° divided by the number of movable electrodes.

In an embodiment of the techniques presented, the stationary electrode plate comprises a fourth phase electrode paired by the control unit with the first phase electrode, a fifth phase electrode paired by the control unit with the second phase electrode, and a sixth phase electrode paired by the control unit with the third phase electrode.

In an embodiment of the techniques presented, the control unit is configured to apply the first excitation signal, the second excitation signal, and the third excitation signal in parallel, and measure the first response, the second response, and the third response concurrently.

In an embodiment of the techniques presented, the control unit is configured to apply the first excitation signal, the second excitation signal, and the third excitation signal sequentially, and measure the first response, the second response, and the third response sequentially.

In an embodiment of the techniques presented, the first movable electrode, the second movable electrode, and the third movable electrode are arranged linearly according to a period, and the control unit is configured to generate the position measurement based on the in-phase component, the quadrature component, and the period.

In an embodiment of the techniques presented, a position sensor comprises a position encoder configured to generate a three-phase signal indicative of a position of the position encoder in response to an excitation signal and a control unit configured to perform a Clarke transform using the three-phase signal to generate an in-phase component and a quadrature component and generate a position measurement based on the in-phase component and the quadrature component.

In an embodiment of the techniques presented, the position measurement comprises an absolute angle measurement.

In an embodiment of the techniques presented, the position encoder comprises three stationary electrodes and movable electrodes spaced from the three stationary electrodes, and the control unit is configured to apply an excitation signal to the three stationary electrodes, wherein the three-phase signal is generated as a function of the excitation signal being applied to the three stationary electrodes, and movement of at least some of the movable electrodes is a function of the excitation signal applied to at least one of the three stationary electrodes.

In an embodiment of the techniques presented, the position encoder comprises a set of movable electrodes, a number of movable electrodes in the set of movable electrodes is a multiple of three, and the movable electrodes in the set are spaced by 360° divided by the number of movable electrodes.

In an embodiment of the techniques presented, the position encoder comprises movable electrodes arranged linearly according to a period and the control unit is configured to generate the position measurement based on the in-phase component, the quadrature component, and the period.

In an embodiment of the techniques presented, a method comprises generating a three-phase signal indicative of a position of a position encoder in response to an excitation signal, performing a Clarke transform using the three-phase signal to generate an in-phase component and a quadrature component, and generating a position measurement of the position encoder based on the in-phase component and the quadrature component.

In an embodiment of the techniques presented, generating the position measurement comprises generating an absolute angle measurement.

In an embodiment of the techniques presented, generating the three-phase signal comprises generating the three-phase signal as a function of application of an excitation signal to three stationary electrodes of the position encoder.

In an embodiment of the techniques presented, generating the position measurement comprises generating an angle measurement.

In an embodiment of the techniques presented, generating the position measurement comprises generating the position measurement based on the in-phase component, the quadrature component, and a period by which movable electrodes of the position encoder are arranged linearly.

The term “computer readable media” may include communication media. Communication media typically embodies computer readable instructions or other data in a “modulated data signal” such as a carrier wafer or other transport mechanism and includes any information delivery media. The term “modulated data signal” may include a signal that has one or more of its characteristics set or changed in such a manner as to encode information in the signal.

Any aspect or design described herein as an “example” and/or the like is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A position sensor, comprising:
a stationary electrode plate comprising:
a first phase electrode;
a second phase electrode; and
a third phase electrode;
a movable electrode plate proximate the stationary electrode plate, comprising:
a first movable electrode;
a second movable electrode; and
a third movable electrode; and
a control unit configured to:
apply a first excitation signal on the first phase electrode;
apply a second excitation signal on the second phase electrode;
apply a third excitation signal on the third phase electrode;
measure a first response on the first phase electrode;
measure a second response on the second phase electrode;
measure a third response on the third phase electrode, wherein movement of at least one of the first movable electrode, the second movable electrode, or the third movable electrode is a function of at least one of the first excitation signal applied to the first phase electrode, the second excitation signal applied to the second phase electrode, or the third excitation signal applied to the third phase electrode;
perform a Clarke transform using the first response, the second response, and the third response to generate an in-phase component and a quadrature component; and
generate a position measurement based on the in-phase component and the quadrature component.

2. The position sensor of claim 1, wherein:
the first phase electrode, the second phase electrode, and the third phase electrode are spaced relative to the first movable electrode, the second movable electrode, and the third movable electrode such that one of the first phase electrode, the second phase electrode, or the third phase electrode overlaps one of the first movable electrode, the second movable electrode, or the third movable electrode.

3. The position sensor of claim 1, wherein:
the first movable electrode comprises three segments.

4. The position sensor of claim 1, wherein:
the position measurement comprises an angle measurement; and
the control unit is configured to:
compare a first ordered pair comprising the in-phase component and the quadrature component to a second ordered pair comprising a previous value of the in-phase component and a previous value of the quadrature component to identify an angle change; and
generate the angle measurement responsive to identifying the angle change.

5. The position sensor of claim 4, wherein:
the control unit is configured to identify the angle change responsive to a distance between the first ordered pair and the second ordered pair exceeding a threshold.

6. The position sensor of claim 1, wherein:
the movable electrode plate comprises a set of movable electrodes including the first movable electrode, the second movable electrode, and the third movable electrode;
a number of movable electrodes in the set of movable electrodes is a multiple of three; and
the movable electrodes in the set are spaced by 360° divided by the number of movable electrodes.

7. The position sensor of claim 1, wherein:
the stationary electrode plate comprises:
a fourth phase electrode paired by the control unit with the first phase electrode;
a fifth phase electrode paired by the control unit with the second phase electrode; and
a sixth phase electrode paired by the control unit with the third phase electrode.

8. The position sensor of claim 1, wherein:
the control unit is configured to:
apply the first excitation signal, the second excitation signal; and
the third excitation signal in parallel; and
measure the first response, the second response, and the third response concurrently.

9. The position sensor of claim 1, wherein:
the control unit is configured to:
apply the first excitation signal, the second excitation signal; and
the third excitation signal sequentially; and
measure the first response, the second response, and the third response sequentially.

10. The position sensor of claim 1, wherein:
the first movable electrode, the second movable electrode, and the third movable electrode are arranged linearly according to a period; and
the control unit is configured to generate the position measurement based on the in-phase component, the quadrature component, and the period.

11. A position sensor, comprising:
a position encoder configured to generate a three-phase signal indicative of a position of the position encoder in response to an excitation signal; and
a control unit configured to:
perform a Clarke transform using the three-phase signal to generate an in-phase component and a quadrature component; and
generate a position measurement based on the in-phase component and the quadrature component.

12. The position sensor of claim 11, wherein:
the position measurement comprises an absolute angle measurement.

13. The position sensor of claim 11, wherein:
the position encoder comprises:
three stationary electrodes; and
movable electrodes spaced from the three stationary electrodes; and
the control unit is configured to:
apply an excitation signal to the three stationary electrodes,
wherein:
the three-phase signal is generated as a function of the excitation signal being applied to the three stationary electrodes, and movement of at least some of the movable electrodes is a function of the excitation signal applied to at least one of the three stationary electrodes.

14. The position sensor of claim 11, wherein:
the position encoder comprises a set of movable electrodes;
a number of movable electrodes in the set of movable electrodes is a multiple of three; and
the movable electrodes in the set are spaced by 360° divided by the number of movable electrodes.

15. The position sensor of claim 11, wherein:
the position encoder comprises:
movable electrodes arranged linearly according to a period; and
the control unit is configured to generate the position measurement based on the in-phase component, the quadrature component, and the period.

16. A method, comprising:
generating a three-phase signal indicative of a position of a position encoder in response to an excitation signal;
performing a Clarke transform using the three-phase signal to generate an in-phase component and a quadrature component; and
generating a position measurement of the position encoder based on the in-phase component and the quadrature component.

17. The method of claim 16, wherein:
generating the position measurement comprises generating an absolute angle measurement.

18. The method of claim 16, wherein:
generating the three-phase signal comprises generating the three-phase signal as a function of application of an excitation signal to three stationary electrodes of the position encoder.

19. The method of claim 16, wherein:
generating the position measurement comprises generating an angle measurement.

20. The method of claim 16, wherein:
generating the position measurement comprises generating the position measurement based on the in-phase component, the quadrature component, and a period by which movable electrodes of the position encoder are arranged linearly.
